(19) United States
(12) Patent Application Publication
(10) Pub. No.: US 2006/0187170 A1
(43) Pub. Date: Aug. 24, 2006

(54) Field sequential liquid crystal display

(76) Inventor: Takeshi Okuno, Suwon-si (KR)

Correspondence Address: CHRISTIE, PARKER & HALE, LLP, PO BOX 7068, PASADENA, CA, 91109-7068, US

(21) Appl. No.: 11/329,823

(22) Filed: Jan. 10, 2006

(30) Foreign Application Priority Data
Feb. 18, 2005 (KR) 2005-13751

(51) Int. Cl. G09G 3/36

(52) U.S. Cl. 345/98

(57) ABSTRACT

A field sequential LCD capable of applying a reset signal having a higher voltage level than a data signal to a liquid crystal so as to represent a predetermined gradation is provided. The field sequential LCD includes an LCD panel having a plurality of pixels for displaying an image, a gate driver supplying a scan signal to the LCD panel through a scan line, a source driver generating a data signal, and a selection circuit coupled between the source driver and the LCD panel. The selection circuit receives the data signal and a reset signal and, in response to a selection signal, supplies the reset signal to the data line during a reset period and supplies the data signal having a lower voltage level than the reset signal to the data line during a data programming period.

### CROSS-REFERENCE TO RELATED APPLICATION

This application claims priority to and the benefit of Korean Patent Application No. 2005-13751, filed Feb. 18, 2005, the entire content of which is incorporated herein by reference.

### FIELD OF THE INVENTION

The present invention relates to a field sequential liquid crystal display (LCD), and more particularly, to a field sequential LCD capable of selectively supplying a reset signal and a data signal to a pixel.

### BACKGROUND OF THE INVENTION

In a field sequential LCD, one frame, defined as a temporal unit of displaying an image, is divided into three fields to drive a liquid crystal. For example, one frame is divided into a red field, a green field and a blue field. The liquid crystal is illuminated by red light emitted from a red lamp turned on during the red field, by green light emitted from a green lamp turned on during the green field, and by blue light emitted from a blue lamp turned on during the blue field.

The field sequential LCD should have a faster response time to a data signal than a general thin film transistor (TFT) LCD. Further, the orientation of the liquid crystal molecules, which are arranged in response to a data signal applied during a previous field, should be initialized before changing the orientation of the liquid crystal molecules in response to a data signal applied during a present field.

FIG. 1 is a timing diagram illustrating a conventional method of driving a field sequential LCD. One frame of an image includes a red field, a green field, and a blue field. Further, each field includes a reset period and a data programming period. During the reset period, the liquid crystal is initialized or arranged according to the data signal applied during the previous field. The initialized liquid crystal that has a sufficiently low transmittance.

For example, the red field includes the reset period and the data programming period. During the reset period of the red field, a reset signal having a voltage level of ΔV is applied to the liquid crystal of a pixel. The reset signal shown has a square waveform. When the reset period of the red field ends, the data programming period of the red field begins. During the data programming period, a red data signal is applied to the initialized liquid crystal and then the liquid crystal arranged according to the red data signal is illuminated with the red light. When the red field ends, the green field begins. During the green field, processes of initializing the liquid crystal, applying a green data signal to the initialized liquid crystal, and turning on the green lamp, are performed in sequence. When the green field ends, the blue field begins. During the blue field, processes of initializing the liquid crystal, applying a blue data signal to the initialized liquid crystal, and turning on the blue lamp, are performed in sequence.

The data signal includes a plurality of square pulses having a uniform voltage level. In FIG. 1, the reset signal required to initialize the liquid crystal has the same level as the data signal. Both the data signal and the reset signal have the voltage level of ΔV. However, when the reset signal has the same voltage level as the data signal, the liquid crystal may not be sufficiently initialized.

When the data signal applied during the previous field causes the liquid crystal to have a relatively high transmittance, the transmittance of the liquid crystal is not sufficiently lowered by the reset signal applied during the reset period of the present field. Consequently, initialization is insufficiently performed. Because the initialization of the liquid crystal is performed depending on both the reset signal applied to the liquid crystal and the duration of the reset period set for initialization, the reset signal should be properly controlled to initialize the liquid crystal sufficiently.

However, it is preferable not to prolong the reset period in order to initialize the liquid crystal sufficiently. The longer the reset period, the shorter the data programming period, and thus the shorter a margin of time for making the liquid crystal respond to the data signal. If the data signal is not applied to the liquid crystal for a sufficiently long period of time, the gradation representation deteriorates.

### SUMMARY OF THE INVENTION

The present invention provides a field sequential LCD device that applies a reset signal having a higher voltage level than a data signal.

In an exemplary embodiment of the present invention, a field sequential LCD includes an LCD panel having a plurality of pixels for displaying an image, a gate driver supplying a scan signal to the LCD panel through a scan line, a source driver generating a data signal, and a selection circuit coupled between the source driver and the LCD panel and selectively supplying the data signal and a reset signal having a higher voltage level than the data signal to the liquid crystal.

In another exemplary embodiment of the present invention, a field sequential LCD includes an LCD panel having a pixel formed in a region in which a scan line intersects a data line for displaying an image, a gate driver supplying a scan signal to the pixel through the scan line, a source driver generating a data signal, and a selection circuit having a plurality of switching devices coupled between the source driver and the LCD panel and supplying the data signal or a reset signal having a higher voltage level than the data signal to the liquid crystal through the data line in response to a selection signal.

In another exemplary embodiment of the present invention, a method for driving an LCD is presented where the LCD includes an LCD panel having a plurality of pixels formed in regions where scan lines from a gate driver and data lines from a source driver intersect and the method includes driving the LCD in fields each filed including a reset period and a data programming period, applying a reset signal to the data lines during the reset period, and applying a data signal to the data lines during the data programming period, where the reset signal is higher than the data signal.

### BRIEF DESCRIPTION OF THE DRAWINGS

FIG. 1 is a timing diagram illustrating a conventional method of driving a field sequential LCD.

FIG. 2 is a timing diagram illustrating a method of driving a field sequential LCD according to an embodiment of the present invention.

FIG. 3 is a block diagram illustrating a field sequential LCD according to an embodiment of the present invention.

FIG. 4A and FIG. 4B are circuit diagrams of a selection circuit provided in the field sequential LCD according to an embodiment of the present invention.

FIG. 5 is a timing diagram illustrating signals for driving the selection circuit shown in FIG. 4A and FIG. 4B.

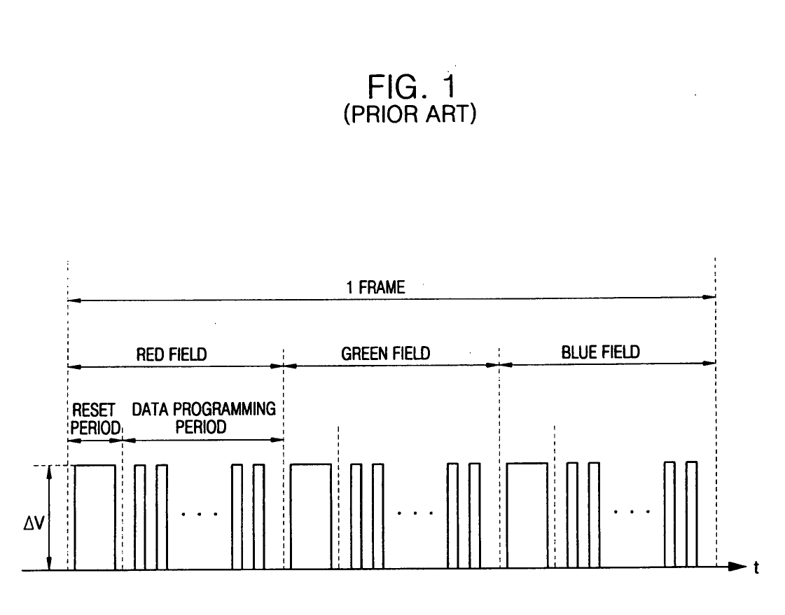

### DETAILED DESCRIPTION

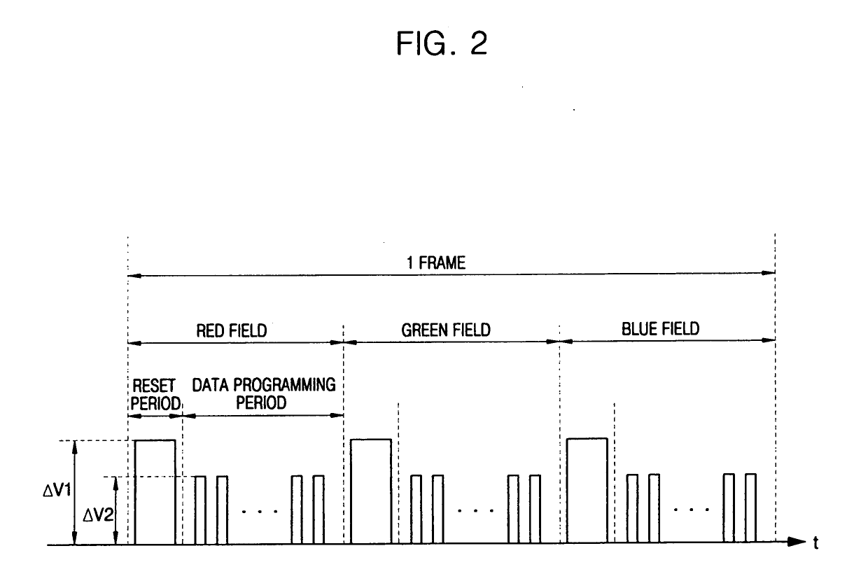

FIG. 2 is a timing diagram illustrating a method of driving a field sequential LCD according to an embodiment of the present invention. One frame, defined as a temporal unit of displaying an image, includes a red field, a green field and a blue field. Further, each field includes a reset period and a data programming period.

During the red field, a reset signal having a voltage level of ΔV1 is applied during the reset period. The reset signal shown has a square waveform. The reset signal may include two or more square waveforms having a voltage level of ΔV1. When the reset signal includes one square waveform, a period corresponding to the reset signal having a high voltage level may be equal to the entire reset period or a portion of the reset period.

According to an embodiment of the present invention, the voltage level ΔV1 of the reset signal is higher than a voltage level ΔV2 of the data signal, so that a liquid crystal is sufficiently initialized by the reset signal and has a sufficiently low transmittance before the next data signal is applied.

When the reset period of the red field ends, the data programming period of the red field begins. During the data programming period, a red data signal is applied to the initialized liquid crystal. The red data signal of the red field shown has the voltage level ΔV2. Further, the red data signal may include a plurality of square waveforms, and may be a pulse width modulation (PWM) signal. While the red data signal is being applied, the liquid crystal of a pixel has a predetermined orientation in response to the red data signal. When the liquid crystal is arranged by the red data signal, a red lamp is turned on to represent a predetermined gradation.

When the red field ends, the green field begins. During the reset period of the green field, the reset signal also having a voltage level of ΔV1 is applied to the liquid crystal, and thus the liquid crystal is initialized. In other words, the transmittance of the liquid crystal arranged according to the red data signal applied during the red field is sufficiently lowered by the reset signal applied during the reset period of the green field. When the liquid crystal is sufficiently initialized, a green data signal is applied to the liquid crystal and a green lamp is turned on.

When the green field ends, the blue field begins. During the reset period of the blue field, the reset signal having a voltage level of ΔV1, which is higher than the voltage level of the data signal ΔV2, is applied to the liquid crystal. As the reset signal is applied to the liquid crystal, the liquid crystal arranged in response to the green data signal is sufficiently initialized. When the reset period ends, a blue data signal is applied to the liquid crystal and a blue lamp is turned on.

Thus, the red, green and blue lamps corresponding to one pixel are turned on in sequence, so that a predetermined image is displayed. Further, the reset signal having a higher voltage level than the data signal is applied to the liquid crystal before applying the data signal to the liquid crystal, so that the liquid crystal may be sufficiently initialized.

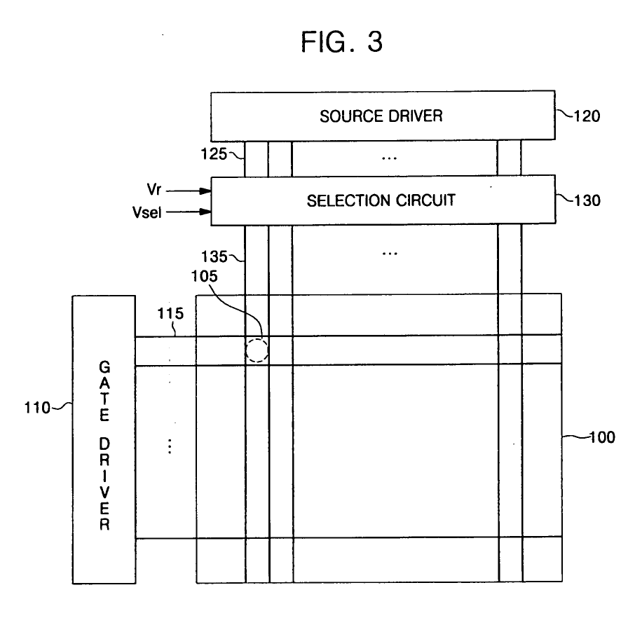

FIG. 3 is a block diagram illustrating a field sequential LCD according to an embodiment of the present invention. The field sequential LCD includes an LCD panel 100, a gate driver 110, a source driver 120, and a selection circuit 130.

The LCD panel 100 includes a plurality of pixels 105 formed in regions where a plurality of data lines 135 intersect a plurality of scan lines 115. When a scan signal is transmitted to a pixel 105 through a scan line 115, a transistor of the pixel 105 is turned on, and thus a data signal is applied from the data line 135 to the liquid crystal via the transistor that was turned on.

The gate driver 110 supplies the scan signal to the pixel 105 through the scan line 115. When the pixel 105 is selected by the scan signal, the pixel 105 can receive the data signal.

The source driver 120 supplies the data signal to the pixel 105 depending on the control exerted by the selection circuit 130. The data signal is supplied to the liquid crystal of the pixel 105 selected by the scan signal, and thus the liquid crystal of the selected pixel 105 is arranged to have a transmittance corresponding to the data signal.

The selection circuit 130 selects either a reset signal Vr or the data signal from the source driver 120 in response to a selection signal Vsel. When the selection circuit 130 selects the reset signal Vr to be applied to the data line 135, the liquid crystal of the selected pixel 105 is initialized. Further, when the selection circuit 130 selects the data signal to be applied from an output line 125 of the source driver 120, the liquid crystal of the selected pixel 105 receives the data signal and a predetermined lamp is turned on.

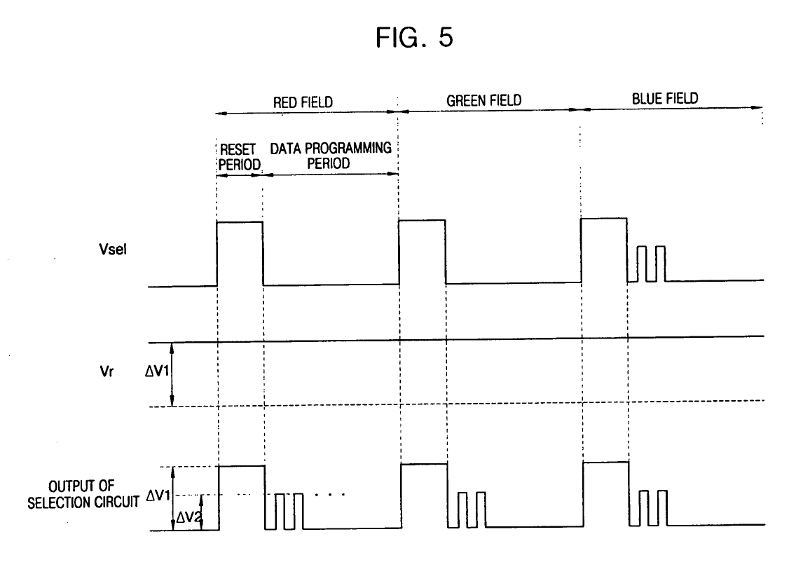

The reset signal Vr has a voltage level of ΔV1 (see FIG. 5) higher than the data signal having a voltage level of ΔV2, and is selectively applied to the liquid crystal. That is, during the reset period for resetting the pixel 105 of the LCD panel 100, the selection circuit 130 selects the reset signal Vr to be supplied to the data line 135. The reset signal Vr is selected by the selection signal Vsel.

During the data programming period, the selection circuit 130 interrupts the reset signal Vr in response to the selection signal Vsel. During the same time, the selection circuit 130 selects the data signal of the source driver 120 depending on the selection signal Vsel, and through the data line 135 supplies the data signal having a voltage level of ΔV2 to the pixel 105 selected by the scan signal.

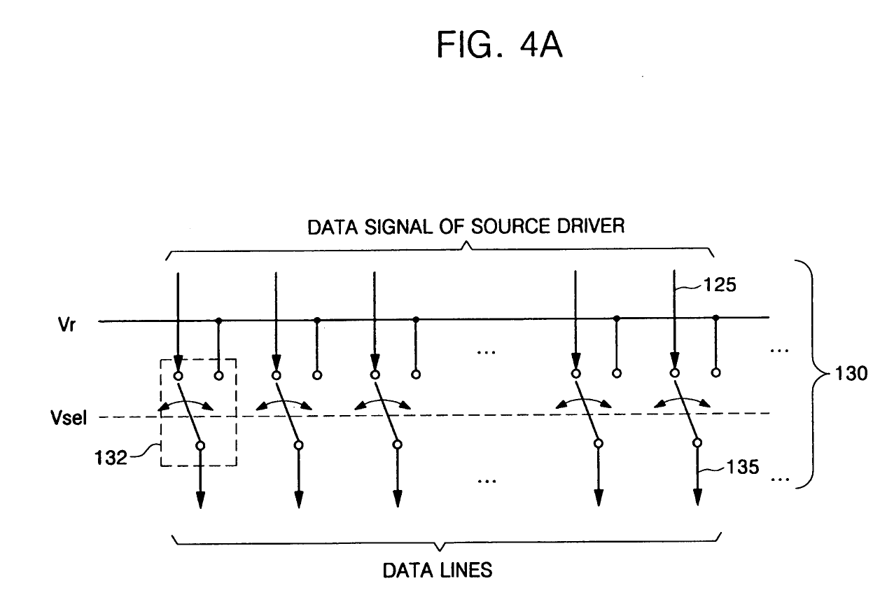

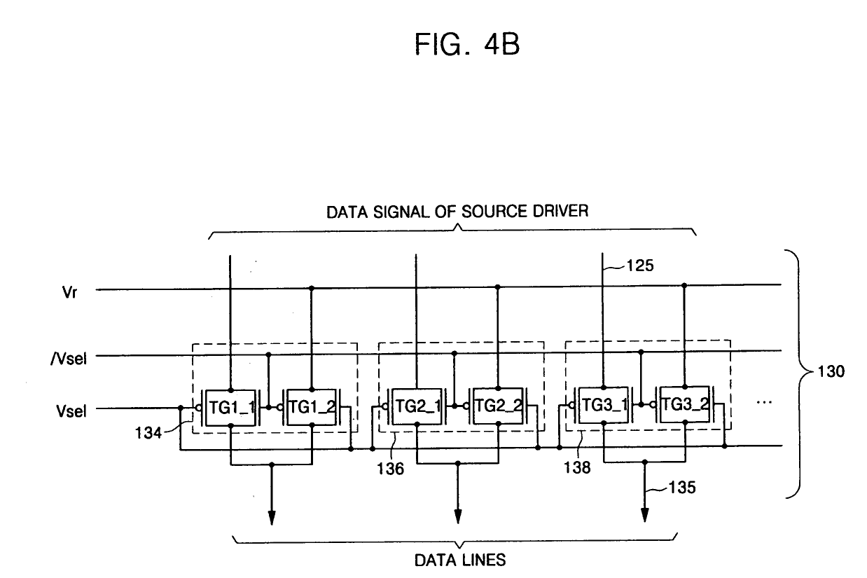

FIGS. 4A and 4B are circuit diagrams of the selection circuit 130 provided in the field sequential LCD of the present invention. The selection circuit 130 includes a plurality of switching devices 132. The switching devices 132 are located in parallel between the source driver 120 and the LCD panel 100.

Each switching device 132 receives a reset signal Vr and a data signal output from the source driver 120, and selects either the reset signal Vr or the data signal to be output to the data line 135 according to a selection signal Vsel. In one embodiment, the switching device 132 is an analog switch so that there is no variation in the voltage level of an applied signal.

The selection signal Vsel is commonly applied to the plurality of switching devices 132. Therefore, the plurality of switching devices 132 are operated together in the same way according to the selection signal Vsel. For example, all switching devices 132 may select the reset signal Vr at the same time according to the selection signal Vsel. Alternatively, all switching devices 132 may select a plurality of data signals at the same time according to the selection signal Vsel.

During the reset period, the switching device 132 selects the reset signal Vr. The reset signal Vr has a higher voltage level than the data signal. Further, during the data programming period, the switching device 132 selects the data signal to be output from the source driver 120 and supplies the selected data signal to the data line 135.

Referring to FIG. 4B, the switching devices shown in FIG. 4A may be multiplexers 134, 136, 138. In one embodiment, each multiplexer 134, 136, 138 is a two-channel complementary metal oxide semiconductor (CMOS) multiplexer. Further, each multiplexer has two transmission gates. For example, a first multiplexer 134 includes two transmission gates TG1_1 and TG1_2, a second multiplexer 136 includes two transmission gates TG2_1 and TG2_2, and a third multiplexer 138 includes two transmission gates TG3_1 and TG3_2. Each multiplexer 134, 136, 138 corresponds to a switching device 134, 136, 138 illustrated in FIG. 4A.

As shown in FIG. 4B, the plurality of multiplexers 134, 136, 138 are located in parallel with each other. For example, the first multiplexer 134 has an output terminal coupled to the data line 135. Within this multiplexer, the transmission gate TG1_1 has an input terminal coupled to an output terminal of the source driver 120, and the transmission gate TG1_2 has an input terminal coupled to a line for the reset signal Vr.

Further, the selection signal Vsel is applied to a p-channel metal oxide semiconductor (PMOS) gate terminal of the transmission gate TG1_1 and an n-channel metal oxide semiconductor (NMOS) gate terminal of the transmission gate TG1_2. Meanwhile, an inverse selection signal /Vsel is applied to an NMOS gate terminal of the transmission gate TG1_1 and a PMOS gate terminal of the transmission gate TG1_2. The second multiplexer 136 and the third multiplexer 138 are coupled to the selection signal Vsel and the inverse selection signal /Vsel in the same manner. Hence, the two transmission gates of each multiplexer are turned on and off in an alternating fashion according to the selection signal Vsel. For example, in the first multiplexer 134, if the first transmission gate TG1_1 is on, the second transmission gate TG1_2 is off.

In one embodiment, the number of multiplexers is equal to the number of output lines 125 of the source driver 120.

In the case where the selection signal Vsel has a high voltage level and the inverse selection signal /Vsel has a low voltage level, the transmission gates TG1_2, TG2_2, TG3_2, etc. are turned on and the reset signal Vr is selected to be transmitted to the data line 135. And, in the case where the selection signal Vsel has a low voltage level and the inverse selection signal /Vsel has a high voltage level, the transmission gates TG1_1, TG2_1, TG3_1, etc. are turned on and the data signal is selected to be transmitted from the source driver 120 to the data line 135.

Thus, the selection circuit 130 selectively transmits the reset signal Vr and the data signal to the data line 135. As mentioned above, the circuit illustrated in FIG. 4B is disclosed as an example of the switching devices illustrated in FIG. 4A. Alternatively, the switching devices may have a different configuration and a different combination of transistors.

FIG. 5 is a timing diagram illustrating signals for driving the selection circuit 130 shown in FIGS. 4A and 4B. The red field includes the reset period and the data programming period. During the reset period, the selection signal Vsel is shifted to a high voltage level. In response to the selection signal Vsel having a high voltage level, the plurality of switching devices 134, 136, 138 provided in the selection circuit 130 select the reset signal Vr.

In one embodiment, the reset signal Vr is a direct current (DC) signal having a voltage level of ΔV1. In FIG. 4B, the transmission gates TG1_2, TG2_2, TG3_2, etc. are turned on by the selection signal Vsel having a high voltage level, so that the reset signal Vr having a voltage level of ΔV1 is transmitted to the data line 135. Then, the reset signal Vr is applied from the data 135 line to the liquid crystal, thereby initializing the liquid crystal.

In the case where the reset signal Vr applied to the data line 135 has two or more square waveforms, the reset signal Vr is applied as two or more square waveforms to the foregoing transmission gates during the reset period.

When the reset period ends and the data programming period begins, the selection signal Vsel is shifted to a low voltage level. In response to the selection signal Vsel having a low voltage level, the selection circuit 130 selects the data signal output from the source driver 120. In FIG. 4B, the transmission gates TG1_1, TG2_1, TG3_1, etc. are turned on, so that the data signal having a voltage level of ΔV2, which is lower than ΔV1, is transmitted to the data line 135. Then, the data signal is applied from the data line 135 to the liquid crystal, so that the liquid crystal is arranged in response to the data signal, and a predetermined lamp is turned on to thereby represent a predetermined gradation.

The foregoing processes are performed in sequence during one frame. For example, the foregoing processes are performed in the order of the red field, the green field, and the blue field. Through the foregoing processes, either the reset signal Vr or the data signal is selected by the selection signal Vsel, and the reset signal Vr having a higher voltage level than the data signal is applied to the data line 135.

According to an embodiment of the present invention, the field sequential LCD includes a selection circuit 130 coupled between the source driver 120 and the LCD panel 100. Either the data signal or the reset signal Vr having a higher voltage level than the data signal is selected by the selection signal Vsel and transmitted to the data line 135. Therefore, the reset signal Vr is selected during the reset period, and thus the liquid crystal is initialized. Further, the data signal is selected by operation of the selection circuit 130 during the data programming period, and thus the data signal is applied to the initialized liquid crystal.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A field sequential liquid crystal display (LCD) comprising:
an LCD panel having a plurality of pixels for displaying an image;
a gate driver for supplying a scan signal to the LCD panel through a scan line;
a source driver for generating a data signal; and
a selection circuit coupled between the source driver and the LCD panel for selectively supplying the data signal and a reset signal having a higher voltage level than the data signal to each of the plurality of pixels.

2. The field sequential LCD according to claim 1, wherein the selection circuit includes a plurality of switching devices for selecting either the reset signal or the data signal in response to a selection signal.

3. The field sequential LCD according to claim 2, wherein each switching device includes an analog switch.

4. The field sequential LCD according to claim 3, wherein each analog switch includes a two-channel multiplexer.

5. The field sequential LCD according to claim 4, wherein each two-channel multiplexer is a two-channel complementary metal oxide semiconductor (CMOS) multiplexer.

6. The field sequential LCD according to claim 4, wherein the two-channel multiplexer includes two transmission gates which are turned on and off in an alternating fashion in response to the selection signal.

7. The field sequential LCD according to claim 1, wherein the reset signal includes at least two square waveforms.

8. A field sequential liquid crystal display (LCD) comprising:
an LCD panel having at least one pixel for displaying an image, the pixel formed in a region where a scan line intersects a data line, the pixel having a liquid crystal portion;
a gate driver for supplying a scan signal to the pixel through the scan line;
a source driver for generating a data signal; and
a selection circuit having a plurality of switching devices coupled between the source driver and the LCD panel for supplying the data signal or a reset signal having a higher voltage level than the data signal to the liquid crystal through the data line in response to a selection signal.

9. The field sequential LCD according to claim 8, wherein the selection circuit supplies the reset signal to the data line during a reset period in response to the selection signal, and supplies the data signal to the data line during a data programming period in response to the selection signal.

10. The field sequential LCD according to claim 8, wherein the switching devices of the selection circuit include a plurality of analog switches and the number of analog switches corresponds to the number of data lines.

11. The field sequential LCD according to claim 10, wherein each analog switch includes a two-channel multiplexer having two transmission gates.

12. The field sequential LCD according to claim 11, wherein each two-channel multiplexer is a two-channel complementary metal oxide semiconductor (CMOS) multiplexer.

13. The field sequential LCD according to claim 11, wherein the two-channel multiplexer receives the data signal and the reset signal, and supplies either the data signal or the reset signal to the data line in response to the selection signal.
